(19) United States
(12) Patent Application Publication
(10) Pub. No.: US 2004/0155741 A1
(43) Pub. Date: Aug. 12, 2004

(54) Flat linear voice coil actuator with planar coils and a spring-type characteristic

(76) Inventor: Mikhail Godin, San Diego, CA (US)

Correspondence Address: GRAY CARY WARE & FREIDENRICH LLP, 153 TOWNSEND, SUITE 800, SAN FRANCISCO, CA, 94107, US

(21) Appl. No.: 10/690,340

(22) Filed: Oct. 21, 2003

Related U.S. Application Data
(60) Provisional application No. 60/420,483, filed on Oct. 21, 2002.

(51) Int. Cl. H01H 9/00

(52) U.S. Cl. 335/220

(57) ABSTRACT

Disclosed is a linear coil actuator having field sub-assemblies, and a coil assembly, in which the field sub-assemblies each have a field blank, and at least one of the field sub-assemblies also includes groups of magnets. Each group of magnets employs magnets having the same or different sizes and arranged to provide a magnetic polarity and a magnetic flux density distribution in the air gap in correspondence to specified load characteristics, such as a spring having a spring constant K. The field sub-assemblies are positioned with respect to one another to form a gap between the field assembly which includes the magnets, and another of the field assemblies, and the coil assembly is moveable in the gap.

### RELATED APPLICATIONS

The present application claims priority under 35 U.S.C. §119(e) from provisional application No. 60/420,483, filed Oct. 21, 2002.

### TECHNICAL FIELD

The present invention relates generally to linear voice coil actuators, and in particular to linear voice coil actuators using a planar coil configuration and providing a force versus stroke characteristic matched to a load characteristic, such as a spring-type characteristic.

### BACKGROUND ART

A new linear voice coil actuator with planar coils is disclosed in U.S. Provisional Patent Application No. 60/343,488 (“'488 Provisional Application”), which has been incorporated in U.S. Non-Provisional application Ser. No. 10/327,316, filed Dec. 20, 2002, assigned to the assignee of the subject application, and incorporated herein by reference. In the '488 Provisional Application, the magnets adjacent to each other in each field sub-assembly are attached to the field blanks in such a way that they form poles of alternating polarities: North-South-North or South-North-South. According to the above '488 Provisional Application, there is provided an additional magnetic flux path 24 for each pair of the magnets 22A/22B of opposite polarity that are separated by the air gap 26, as can be seen in FIG. 5 of this and the referenced application.

Traditionally, desired force versus stroke characteristics are obtained in linear actuators by controlling the current being supplied to the actuator coil or coils. Thus, open or closed loop control functions may be required to control the current being applied to the coils as a function of the stroke position so as to produce a desired magnitude of force at various positions of the stroke. Providing such control functions can involve significant costs and complexities beyond the design of the actuator itself.

It is therefore desirable to have a linear actuator that is capable of providing selected force versus stroke characteristics at a lower cost and complexity than in the past. It is also desirable to have such a linear actuator in which the need for open or closed loop control of the actuator coil current can be reduced or eliminated.

### SUMMARY OF THE INVENTION

The above problems and disadvantages of prior linear actuators are addressed by the present invention of an actuator for operating upon a load having load characteristics, including a field assembly comprising a plurality of magnets configured to provide flux density distributions selected as a function of the load characteristics. The configuration of the plurality of magnets can be generalized to a magnetic structure which is dimensioned to provide the desired flux density distributions.

The plurality of magnets can be arranged in a sequence so that at least two adjacent ones of the plurality of magnets having a first polarity are followed by at least another of the plurality of magnets having a polarity different from the first polarity, and flux distributions provided by the sequence correspond to the load characteristics.

In one embodiment of the linear actuator of the present invention, a first plurality of magnets of one polarity is followed by a second plurality of magnets of a different polarity positioned on the first field blank in a direction of motion of the linear actuator. A coil assembly is provided including a generally planar coil comprising a first force generating portion spaced apart from a second force generating portion so that the first force generating portion is positioned over ones of the first plurality of magnets whenever the second force generating portion is positioned over ones of the second plurality of magnets.

In particular, an embodiment of the present invention includes a plurality of field sub-assemblies each comprising a field blank, wherein a first one of the plurality of field sub-assemblies includes consecutive groups of magnets. Each one of the consecutive groups of magnets includes a plurality of magnets arranged to have a selected magnetic polarity and to have a selected magnetic flux density distribution. The first one of the plurality of field sub-assemblies is positioned with respect to a second one of the plurality of field sub-assemblies to form a gap between them. A coil assembly is provided which includes at least one coil positioned in a plane within the gap, wherein the plane is substantially parallel to the direction of motion of the linear coil actuator.

In this embodiment of the linear actuator, the field blanks of each of the plurality of field sub-assemblies comprise a generally planar portion, and additional sections extending along edges of the planar portion in the direction of motion. When first and second ones of the plurality of field sub-assemblies are positioned to form the gap, corresponding additional sections of the field blanks in the first and second field sub-assemblies are adjacent one another and form a flux path perpendicular to the direction of motion for a magnet of the first field sub-assembly.

By configuring the distribution of the flux densities in the air gap to correspond to expected load characteristics, for example, by using a plurality of magnets creating different average flux densities, to which the coil is exposed, there can be a reduction or elimination of any requirement of a control function for controlling the magnitude and timing of current supplied to the actuator coil or coils.

The present invention also includes a method for configuring a linear actuator having a field assembly and a coil assembly for operation upon a load having load characteristics which vary over a stroke, which comprises the steps of fashioning a magnet structure of the field assembly along a direction of motion of the linear actuator to distribute flux densities in correspondence to the variations in the load characteristics over the stroke; and configuring a coil of the coil assembly to be responsive to the distributed flux densities.

These concepts can be employed in a flat linear voice coil actuator with planar coils, to produce a compact, low cost actuator with a selected force versus stroke characteristic, such as that of a spring having a spring constant K.

It is therefore an object of the present invention to provide an actuator in which a magnet structure of the field assembly provides distributed flux densities over the stroke of the actuator in correspondence to required load characteristics.

It is a further object of the present invention to provide a linear actuator employing generally planar coils and a plurality of sized magnets arranged in a sequence and a pattern of polarities to provide a distribution of flux densities over the stroke which correspond to a required load characteristic.

It is another object of the present invention to provide a linear actuator which provides a force versus stroke characteristic that corresponds to a required load characteristic, such as a spring characteristic, with a reduced requirement for any coil current control mechanisms.

It still another object of the present invention to provide a method for configuring a linear actuator so that the magnet structure of the field assembly of the actuator provides a distribution of flux densities in the air gap over the stroke which corresponds to a required load characteristic.

These and other objectives, features and advantages of the present invention will be better understood upon consideration of the following detailed description and accompanying drawings.

### DESCRIPTION OF THE DRAWINGS

FIG. 1 is a simplified perspective view of an embodiment of a linear voice coil actuator in accordance with the present invention.

FIG. 2A is a simplified perspective view of two field sub-assemblies of an embodiment of the present invention.

FIGS. 2B and 2C are simplified illustrations of possible orientations of a coil of the coil sub-assembly, and magnets of the field sub-assembly, of an embodiment of the present invention.

FIG. 3 is a simplified illustration of the coil sub-assembly of an embodiment of the present invention.

FIG. 4 is an exploded view of the linear voice coil actuator embodiment of FIG. 1.

FIG. 5 is a simplified cross sectional view of the linear actuator of FIG. 1, taken along lines 5-5 shown in FIG. 2A.

FIG. 6 is an illustrative plot of a Force versus Stroke characteristic for the embodiment of the invention depicted in FIG. 2A.

### DETAILED DESCRIPTION OF THE INVENTION

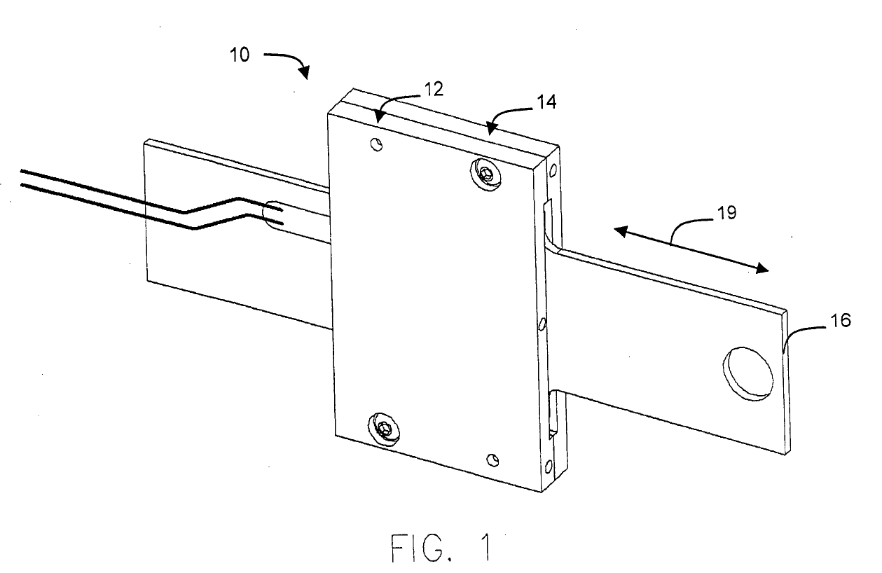

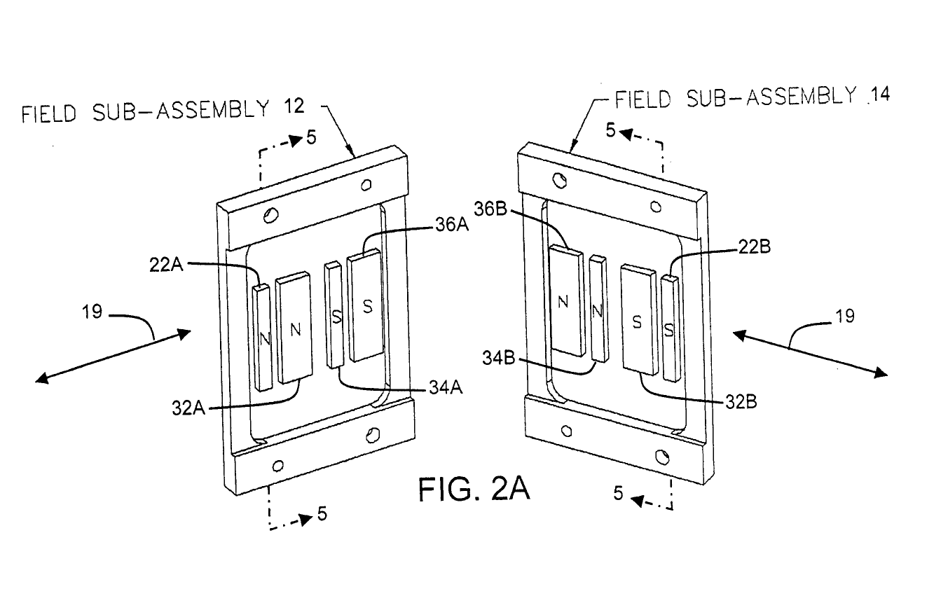

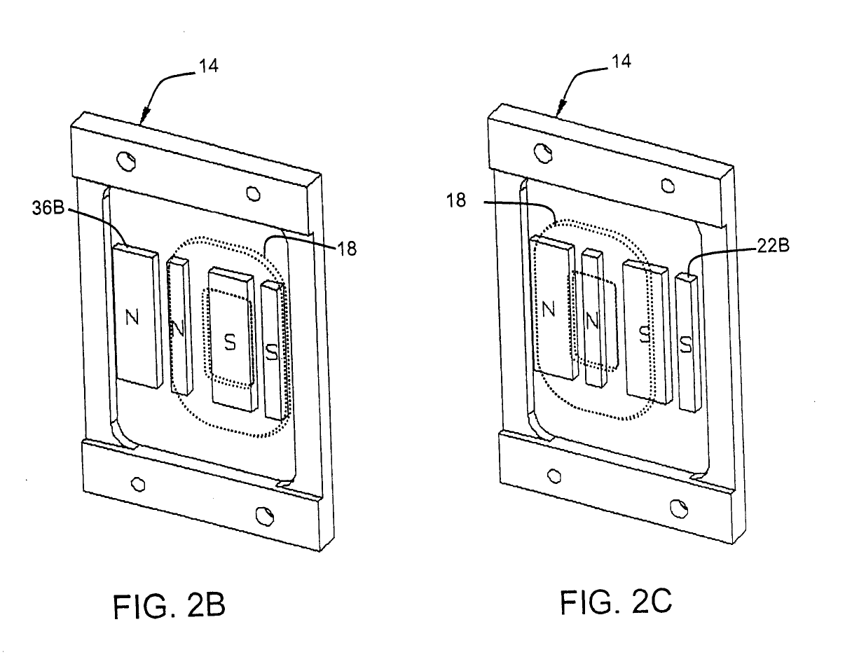

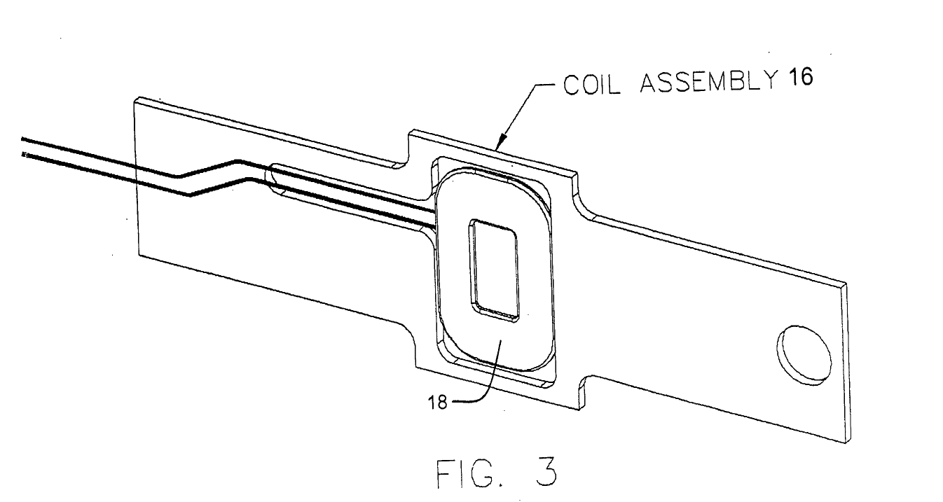

The embodiment of the present invention shown as linear voice coil actuator 10 in FIG. 1 includes two field sub-assemblies 12, 14, and a coil assembly 16. FIG. 2A provides a view of sub-assemblies 12 and 14, while FIG. 3 provides a more complete view of coil assembly 16. The embodiment shown in FIG. 1 is analogous to an actuator described in the above '488 Provisional Application but differs in at least the following aspect:

In the above '488 Provisional Application, the magnets adjacent to each other in each field sub-assembly are attached to the field blanks in such a way, that they form the poles of alternating polarities: North-South-North or South-North-South. In contrast, in accordance with the embodiment of FIGS. 1 and 2A, in each field sub-assembly there are at least two magnets of the same polarity spaced apart from each other and from another group of magnets of the opposite polarity, which form the poles of alternating polarity. An example of this pattern is provided in FIG. 2A.

The pattern shown in FIG. 2A may be repeated along the direction of motion 19. This repetition of the pattern can be done to increase the force of the actuator. For example, if two sets of four magnets were used instead of one, the force developed by the actuator would be twice as high. In this case, two coils would be required.

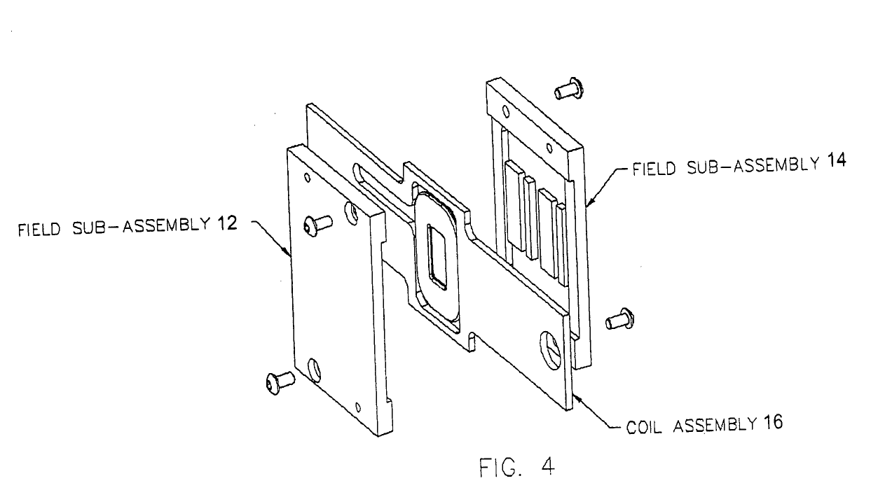

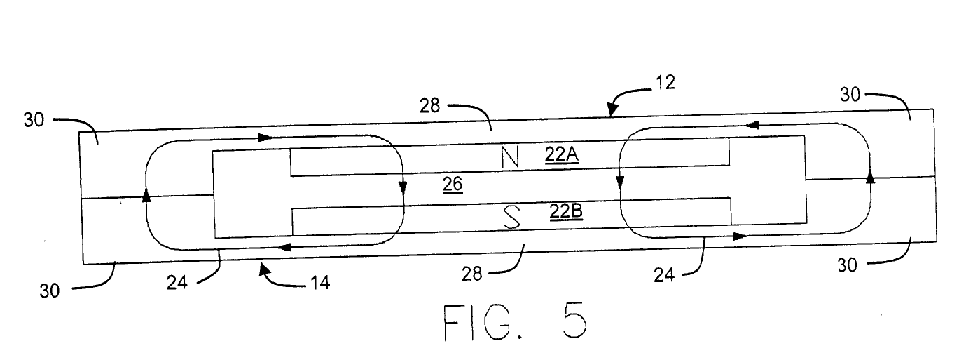

FIG. 4 shows a one-coil arrangement of the present invention. FIG. 5 depicts a cross-section of the actuator along line 5-5 of FIG. 2A. (The coil of the actuator is not shown for simplicity.) It is to be noted that the arrangement provides another path 24 for magnetic flux from each pair of the magnets of opposite polarity that are separated by the air gap 26, for example, magnets 22A and 22B. The cross-section of the actuator illustrated in FIG. 5 is taken perpendicular to the direction of motion 19 (see FIG. 2A), which is into or out of the page in FIG. 5. The field blanks in this embodiment may include additional sections 30 which provide flux paths perpendicular to the direction of motion for each pair of magnets of opposite polarity that are separated by the gap. In other words, provided in this embodiment of the present invention are flux paths which lie generally in a plane perpendicular to the direction of motion 19.

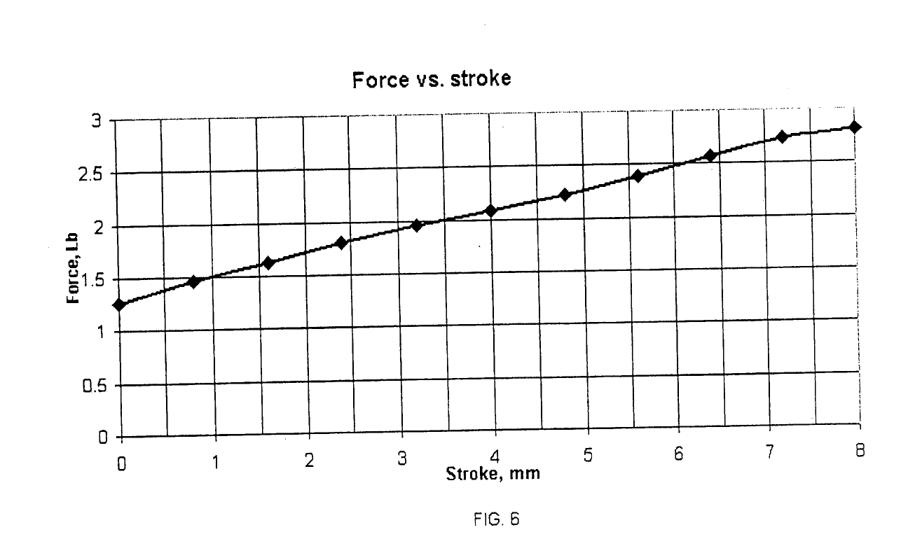

This above described configuration of a linear actuator in accordance with the present invention can result in a design with a characteristic similar to that of a mechanical spring (see FIG. 6), or other desired load characteristic.

The methodology of the present invention, implemented in the embodiments disclosed in the figures, is to distribute the magnetic field sources across the stroke area of the field sub-assemblies to provide a magnetic field distribution in the air gap which better matches the characteristics of the load being handled by the actuator. By tailoring the distribution of the magnetic field sources in this manner, one can simplify the actuator design, and substantially reduce or eliminate the need to control the current applied to the coil in order to obtain desired force characteristics. This distribution of magnetic field sources can take the form of varying the size of each of the magnets, such as varying the widths of the magnets as a function of stroke position along the field assembly, so that the magnetic flux density in the air gap varies as a function of stroke position.

For example, in the embodiment of the present invention depicted in FIG. 2A, the sizing and distribution of the magnets 22A/22B, 32A/32B, 34A/34B and 36A/36B, are selected to match a particular load, namely a spring having a spring constant K, and the frictional forces expected to be present in the actuator. The group of magnets 22B and 32B provide a distributed magnetic field having a South polarity, while the group of magnets 22A and 32A provide a distributed magnetic field having a North polarity. Magnets 22A and 22B are smaller in size, (in this embodiment, smaller in width) than magnets 32A and 32B of their respective groups.

Therefore, in the depicted embodiment in FIG. 2A, at the beginning of the stroke of the actuator, the force generating sections of coil 18 are positioned between the magnet pairs 22A/22B and 34A/34B having the smaller size, and therefore lower average flux density to which the coil is exposed. At the end of the stroke, the force generating portions of coil 18 are positioned between magnet pairs 36A/36B and 32A/32B which are larger in size and therefore provide a higher average flux density. As a result, coil 18 generates a greater force at the end of the stroke as compared with the beginning of the stroke. FIG. 2B illustrates the position of coil 18 (in phantom) at the beginning of the stroke, and FIG. 2C illustrates the position of coil 18 (in phantom) at the end of the stroke.

In FIGS. 2B and 2C, it can be seen that coil 18 has a first force generating portion spaced apart from a second force generating portion. In FIG. 2B, it can be seen that the spacing of the first and second force generating portions is set so that the first force generating portion is positioned over the smaller magnet of North polarity while the second force generating portion is positioned over the smaller magnet of South polarity. This spacing is such that in FIG. 2C, at the end of the stroke, the first force generating portion is positioned over the larger magnet of North polarity while the second force generating portion is positioned over the larger magnet of South polarity. Thus, in this arrangement, the first force generating portion is positioned over ones of the magnets of North polarity whenever the second force generating portion is positioned over ones of the magnets of South polarity.

It will be appreciated by those skilled in the art that the result is a stroke versus force pattern that can closely match the load characteristics of a spring.

Preferably, the magnetic field distribution in the air gap provided by the permanent magnets matches the expected load and friction characteristics as closely as possible. In this way, the need to control the current being supplied to the coil in order to provide the desired stroke versus force characteristics can be minimized or eliminated. If variations in the load are expected, the magnitude of the magnetic field is preferably increased above what would be needed to provide the nominal load characteristics.

In the embodiment of the present invention depicted, for example, in FIG. 2A, and which can provide the force versus stroke characteristics of FIG. 6, the widths of the smaller magnets 22A/22B and 34A/34B are about 40 per cent of the width of the larger magnets 32A/32B and 36A/36B of their respective polarity group.

In another embodiment of the invention, only one of the field sub-assemblies, 12 or 14, needs to have any magnets. In this embodiment, the permanent magnets would be positioned on only one side of the coil or coils 18.

Therefore, one embodiment of the invention involves a linear coil actuator including a plurality of field sub-assemblies, and a coil assembly. The plurality of field sub-assemblies each comprise a field blank, and at least one of the plurality of field sub-assemblies also includes a plurality of magnets of the same and alternating polarity and of the same or different widths in the direction of motion.

The plurality of field sub-assemblies are positioned with respect to one another to form a gap between the at least one of the plurality of field assemblies which includes the plurality of magnets, and another of the plurality of field assemblies. The coil assembly of this embodiment includes coils that are positioned in the same plane within the gap, wherein the plane is substantially parallel to the direction of motion of the linear coil actuator.

Another embodiment of the present invention is directed to a linear coil actuator including a plurality of field sub-assemblies with additional sections, and a coil assembly. The plurality of field sub-assemblies each comprise a field blank, and at least one of the plurality of field sub-assemblies also includes a plurality of magnets of the same and alternating polarity and of the same or different widths in the direction of motion, wherein the magnets are spaced apart from each other. The plurality of field sub-assemblies are positioned with respect to one another to form a gap between the at least one of the plurality of field assemblies which includes the plurality of magnets, and another of the plurality of field assemblies. The field blanks in this embodiment further include additional sections which provide a flux path perpendicular to the direction of motion for each pair of magnets of opposite polarity that are separated by the gap.

In a further embodiment of the above linear coil actuator, the field blanks of each of the plurality of field sub-assemblies comprise a generally planar portion, and the additional sections extend above the planar portion and along the direction of motion. When a first one of the plurality of field sub-assemblies and a second one of the plurality of field sub-assemblies are positioned to form the gap, the additional sections of the first and second field sub-assemblies are positioned in contact with or adjacent one another. The provided perpendicular flux path is formed through a magnet of the first field subassembly, across the gap to a magnet of opposite polarity (if any) of the second field subassembly, through the planar portion and then one of the additional sections of the field blank of the second field subassembly, through the adjacent additional section and then the planar portion of the first field subassembly, and back to the magnet of the first field subassembly. (In embodiments in which only one of the field assemblies includes magnets, the perpendicular flux path will extend from a magnet of the one field assembly, across the gap, and to the planar portion of the opposite field assembly.)

In the above described embodiments, the magnetic flux density distribution which is provided by the magnets in the air gap is varied by manipulating the distribution of the magnetic field sources—for example, by manipulating the number and size of magnets used to provide each polarity grouping. Thus, a South polarity magnet grouping can have two magnets of the same or different size so that the magnitude of the South polarity magnetic flux density that is provided as a function of coil position will depend upon the order and location in which these magnets are arranged.

In accordance with the present invention, a linear voice coil actuator includes a plurality of field sub-assemblies, and a coil assembly. The plurality of field sub-assemblies each comprise a field blank, and at least one of the plurality of field sub-assemblies also includes a plurality of groups of magnets, each group including a plurality of magnets having the same or different sizes and arranged to provide a magnetic polarity and a magnetic flux density distribution. The plurality of field sub-assemblies are positioned with respect to one another to form a gap between the at least one of the plurality of field assemblies which includes the plurality of magnets, and another of the plurality of field assemblies. The coil assembly of this embodiment includes at least one coil positioned in the same plane within the gap, wherein the plane is substantially parallel to the direction of motion of the linear coil actuator.

It is to be understood that the present invention is not limited to a single coil, and that multiple coils can be employed. It is also to be understood that number of magnets comprising the group of magnets which supply a particular magnetic polarity is not limited in number to two magnets, but can be more than two. It is also to be understood that in accordance with the present invention, the sizes of the various magnets are varied according to the particular force characteristics sought to be achieved. This can include varying the length, width and/or thickness of the magnets, or any other variation of characteristics of the magnets which provides the desired magnetic flux density distribution in the air gap over the stroke length. Coil size is determined by the required force. The spacing set between smaller versus larger sized magnets (e.g. between 22B and 32B) within a polarity group is determined by the required flux density distribution. The spacing between one size of magnet in one polarity group (e.g. 22B) relative to the same size magnet (e.g. 34B) in another polarity group is determined by the stroke.

The terms and expressions employed herein are terms of description and not of limitation, and there is no intent in the use of such terms and expressions of excluding equivalents of the features shown and described, or portions thereof, it being recognized that various modifications are possible within the scope of the invention claimed.

What is claimed is:

1. An actuator for operating upon a load having load characteristics, including
a field assembly comprising a first plurality of magnets configured to provide flux density distributions in an air gap selected as a function of the load characteristics; and
a coil assembly.

2. The actuator of claim 1, wherein dimensions of the first plurality of magnets are selected to provide the selected flux density distributions in the air gap.

3. The actuator of claim 2, wherein the first plurality of magnets are aligned in alternating groups, so that magnets in one of the alternating groups have a first polarity, and magnets in an adjacent alternating group have a second polarity opposite to the first polarity.

4. The actuator of claim 2, wherein the first plurality of magnets are positioned in a first set of aligned groups on a field blank, and at least one of the aligned groups of the first set of aligned groups includes a pair of magnets having the same polarity.

5. The actuator of claim 2, wherein the load characteristics correspond to a spring having a spring constant K.

6. The actuator of claim 1, wherein the field assembly includes a first field blank positioned to face a second field blank, the first and second field blanks each comprising a planar portion and additional sections which provide flux paths perpendicular to a direction of motion of the coil assembly, and further wherein the first plurality of magnets are positioned along the direction of motion on the planar portion of the first field blank.

7. The actuator of claim 6, wherein the first plurality of magnets are arranged in a first pattern of polarities, and further including a second plurality of magnets positioned on the planar portion of the second field blank to oppose the first plurality of magnets, and further wherein the second plurality of magnets are arranged in a second pattern of polarities which is a complement of the first pattern of polarities.

8. The actuator of claim 4, further including a second set of aligned groups of magnets positioned on an opposing field blank, wherein the first set of aligned groups are arranged in a first pattern of polarities, and further wherein the second set of aligned groups of magnets are arranged in a second pattern of polarities which is a complement of the first pattern of polarities.

9. The actuator of claim 1, wherein the first plurality of magnets is further configured to provide a flux density distribution in the air gap as a function of friction characteristics.

10. A linear actuator for operating upon a load having load characteristics, including
a field assembly comprising distributed magnet field sources which provide a flux density distribution in an air gap corresponding to the load characteristics; and
a coil assembly.

11. The linear actuator of claim 10, wherein the distributed magnet field sources are further configured to provide the flux density distribution in the air gap as a function of friction characteristics.

12. The linear actuator of claim 11, wherein the friction characteristics correspond to friction characteristic of the load.

13. The linear actuator of claim 10, wherein dimensions of the magnet field sources are selected so that the flux density distribution in the air gap provided by the magnet field sources increases in a direction of motion of the linear actuator.

14. A linear actuator for operating upon a load having load characteristics, including
a field assembly comprising a magnet structure which includes a plurality of magnets arranged in a sequence so that at least two adjacent ones of the plurality of magnets having a first polarity are followed by at least another of the plurality of magnets having a polarity different from the first polarity, and flux distributions in an air gap provided by the sequence correspond to the load characteristics; and
a coil assembly.

15. The linear actuator of claim 14, wherein the sequence of magnets is further configured to provide a flux density distribution in the air gap as a function of friction characteristics.

16. The linear actuator of claim 15, wherein the friction characteristics correspond to friction characteristics of the linear actuator.

17. The linear actuator of claim 14, wherein the load characteristics correspond to a spring having a spring constant K.

18. The linear actuator of claim 17, wherein the dimensions of the plurality of magnets are selected so that the flux density distribution in the air gap provided by the plurality of magnets decreases in a direction of motion of the linear actuator.

19. A linear actuator including
a field assembly comprising
a first field blank,
a first plurality of magnets of one polarity followed by a second plurality of magnets of a different polarity positioned on the first field blank in a direction of motion of the linear actuator, and
a coil assembly including a generally planar coil comprising a first force generating portion spaced apart from a second force generating portion so that the first force generating portion is positioned over ones of the first plurality of magnets whenever the second force generating portion is positioned over ones of the second plurality of magnets.

20. The linear actuator of claim 19, wherein the first and second pluralities of magnets are arranged in a first pattern of polarities, and further including a third and fourth pluralities of magnets positioned on a planar portion of a second field blank to oppose the first plurality of magnets and to form a gap, and further wherein the third and fourth plurality of magnets are arranged in a second pattern of polarities which is a complement of the first pattern of polarities, and the generally planar coil is moveable along the gap.

21. The linear actuator of claim 20, including additional sections extending along the planar portion of the first and second field blanks in the direction of motion, so that when first and second ones of the field blanks are positioned to form the gap, the additional sections form a flux path perpendicular to the direction of motion.

22. The linear actuator of claim 21, wherein the perpendicular flux path is a portion of an actuator flux path which extends through a magnet of the first plurality of magnets, across the gap to a magnet of the third plurality of magnets and the planar portion of the second field blank, through at least one of the additional sections and to the planar portion of the first field blank, and back to the magnet of the first plurality of magnets.

23. The linear actuator of claim 21, wherein the perpendicular flux path is a portion of an actuator flux path which lies generally in a plane perpendicular to the direction of motion.

24. A linear actuator operational in a direction of motion including
a plurality of field sub-assemblies each comprising a field blank, and wherein at least one of the plurality of field sub-assemblies includes a first sequence of magnets of one polarity followed in the direction of motion by a second sequence of magnets of a different polarity, wherein the plurality of field sub-assemblies are positioned with respect to one another to form a gap between the at least one of the plurality of field assemblies which includes the sequences of magnets, and another of the plurality of field assemblies; and
a coil assembly including coils positioned within the gap in a plane substantially parallel to the direction of motion.

25. The linear actuator of claim 24, wherein the magnets in the first sequence of magnets have different widths and the magnets in the second sequence have different widths.

26. The linear actuator of claim 24, wherein the magnets in the first sequence of magnets have substantially the same widths as corresponding magnets in the second sequence of magnets.

27. The linear actuator of claim 24, wherein at least one magnet in the first sequence of magnets has substantially the same width as at least one magnet in the second sequence of magnets.

28. A linear actuator operational in a direction of motion including
a plurality of field sub-assemblies each comprising a field blank, wherein a first one of the plurality of field sub-assemblies includes consecutive groups of magnets, each one of the consecutive groups of magnets including a plurality of magnets arranged to have a selected magnetic polarity and to produce a selected magnetic flux density distribution in an air gap, and further wherein the first one of the plurality of field sub-assemblies is positioned with respect to a second one of the plurality of field sub-assemblies to form the air gap between them; and
a coil assembly including at least one coil positioned in a plane within the air gap, wherein the plane is substantially parallel to the direction of motion of the linear coil actuator.

29. The linear actuator of claim 28, wherein the field blanks of each of the plurality of field sub-assemblies comprise a generally planar portion, and additional sections extending along edges of the planar portion in the direction of motion, so that when first and second ones of the plurality of field sub-assemblies are positioned to form the gap, corresponding additional sections of the field blanks in the first and second field sub-assemblies are adjacent one another to form a flux path perpendicular to the direction of motion for a magnet of the first field sub-assembly.

30. The linear actuator of claim 29, wherein the perpendicular flux path forms a portion of an actuator flux path which extends from the magnet of the first field assembly, across the air gap to a planar portion of the second field sub-assembly, through a corresponding additional section of the field blank of the second field sub-assembly, through an adjacent corresponding additional section and then a planar portion of the first field sub-assembly, and back to the magnet of the first field subassembly.

31. The linear actuator of claim 29, further including a sequence of magnets positioned on the second one of the plurality of field sub-assemblies, wherein the consecutive groups of magnets are arranged in a first pattern of polarities, and further wherein the sequence of magnets are arranged in a second pattern of polarities which is a complement of the first pattern of polarities, and so that the actuator flux path also includes a magnet of the sequence of magnets having a polarity opposite the polarity of the magnet of the first field subassembly.

32. A method of configuring a linear actuator having a field assembly and a coil assembly for operation upon a load having load characteristics which vary over a stroke, comprising the steps of
fashioning a magnet structure of the field assembly along a direction of motion of the linear actuator to distribute flux densities in an air gap in correspondence to the variations in the load characteristics over the stroke; and
configuring a coil of the coil assembly to be responsive to the distributed flux densities.

33. The method of claim 32, wherein the fashioning step includes the steps of
dimensioning first and second magnets, wherein the first magnet creates a first average flux density of a selected polarity to which a side of the coil is exposed, and the second magnet creates a second average flux density of a selected polarity to which the side of the coil is exposed and is positioned adjacent the first magnet to form a first group;
dimensioning third and fourth magnets to have a polarity opposite to the selected polarity, and average flux densities in the air gap to which another side of the coil is exposed corresponding to the first and second average flux densities in the air gap, respectively, wherein the fourth magnet is positioned adjacent the third magnet to form a second group, and the second group is positioned along the direction of motion in a sequence with the first group.

34. The method of claim 32, wherein the load characteristics correspond to a spring having a spring constant K, and further wherein the fashioning step includes the step of distributing flux densities in the magnetic structure to provide a variation of flux density in the air gap along the direction of motion in correspondence with the spring having the spring constant K.

35. The method of claim 32, wherein the fashioning step includes the step of selecting the physical characteristics of the magnetic structure to provide the distribution of flux density in the air gap.

36. The method of claim 35, wherein the selecting step includes configuring the width dimension of the magnet structure along the direction of motion.

37. The method of claim 35, wherein the selecting step includes the step of providing a plurality of spaced apart magnets, each providing a different average flux density in the air gap to which a coil side is exposed.

38. The method of claim 34, wherein the distributing step includes the steps of
selecting first and second magnets, wherein the first magnet has a first width and a selected polarity, and the second magnet has a second width less than the first width and the selected polarity and is positioned adjacent the first magnet to form a first group;
selecting third and fourth magnets having a polarity opposite to the selected polarity, and widths corresponding to the first and second widths, respectively, wherein the fourth magnet is positioned adjacent the third magnet to form a second group, and the second group is positioned along the direction of motion in a sequence with the first group.

39. The method of claim 32, wherein the fashioning step includes the step accounting for friction characteristics when creating a required flux density distribution in the air gap.

40. The method of claim 32, wherein the fashioning step includes the steps of
positioning the magnetic structure on a first field blank having a generally planar portion; and
forming additional sections extending along the planar portion in the direction of motion, so that when the first field blank is positioned opposite a second field blank to form the air gap, corresponding additional sections form a flux path perpendicular to the direction of motion for the magnet structure.
